(19) United States
(12) Patent Application Publication
(10) Pub. No.: US 2026/0245850 A1
(43) Pub. Date: Aug. 20, 2026

(54) Power Supply Including Amplitude Calibration and Phase Correction for Mass Spectrometry

(71) Applicant: DH Technologies Development Pte. Ltd., Singapore (SG)

(72) Inventors: Andrei TUDOR, Toronto (CA); Tiberiu GERA, Etobicoke (CA)

(73) Assignee: DH Technologies Development Pte. Ltd., Singapore (SG)

(21) Appl. No.: 19/160,949

(22) PCT Filed: Feb. 29, 2024
(86) PCT No.: PCT/IB2024/051973

§ 371 Date: Aug. 29, 2025

Related U.S. Application Data
(60) Provisional application No. 63/449,787, filed on Mar. 3, 2023.

(51) Int. Cl. H01J 49/02; G01N 27/622

(52) U.S. Cl. CPC H01J 49/022; G01N 27/622

(57) ABSTRACT

In one aspect, a circuit for generating an asymmetric waveform for application to electrodes of a differential mobility mass (DMS) spectrometer is disclosed, which includes two digital waveform synthesizers for generating digital waveforms, which are converted to analog waveforms for application to electrodes of the DMS spectrometer. Analog feedback signals associated with the applied waveforms are digitized into digital amplitude calibration feedback signals and digital phase correction feedback signals. An amplitude calibration circuit is employed apply an RF calibration factor to at least one of the digital waveform synthesizers based on digital the amplitude calibration feedback signals. A digital passband filter is employed to filter the digital phase correction feedback signals, which are then employed to determine a phase correction signal for application to at least one of the digital waveform synthesizers for maintaining a substantially constant phase difference between the waveforms generated by the digital waveform synthesizers.

### RELATED APPLICATIONS

This application claims priority to U.S. Provisional Application No. 63/449,787 filed on Mar. 3, 2023, the contents of which are incorporated herein in their entirety.

### TECHNICAL FIELD

The present disclosure relates to methods and systems for performing mass spectrometry and more particularly to circuits for generating waveforms for application to electrodes of a differential mobility mass spectrometer.

### BACKGROUND

Mass spectrometry (MS) is an analytical technique for determining the elemental composition of a substance. Specifically, MS measures a mass-to-charge ratio (m/z) of ions generated from a test substance. MS can be used to identify unknown compounds, to determine isotopic composition of elements in a molecule, to determine the structure of a particular compound by observing its fragmentation, and to quantify the amount of a particular compound in a sample. Mass spectrometers detect ions and as such, a test sample must be converted to an ionic form during mass analysis.

In differential mobility mass spectrometry, ions are separated based on the difference in their mobility. More specifically, ions drift through a mobility cell, which typically includes two electrodes that are separated by a substantially uniform gap. The application of an asymmetric waveform to the electrodes can create a separation field that exposes the ions to high and low electric field conditions. An ion will migrate toward one or the other electrode depending on its high field and low field mobility. A small DC field can be applied between the electrodes to steer the ions back to the central axis of the mobility cell such that they can be transmitted to a downstream component, such as a mass spectrometer.

The electrodes utilized in a mobility cell can be, for example, in the form of flat planar electrodes that provide a homogeneous electric field or curved cell geometries that provide an inhomogeneous electric field. The former is typically referred to as a differential mobility spectrometer (DMS) and the latter is referred to as a High Field Asymmetric Waveform Ion Mobility Spectrometer, both of which are herein collectively referred to as ion mobility spectrometers.

### SUMMARY

In one aspect, a power supply includes a first radio frequency (RF) generator for generating a first waveform, a second RF generator for generating a second waveform, a first amplitude calibration circuit operably coupled to said first RF generator for calibrating an amplitude of said first waveform, a second amplitude calibration circuit operably coupled to said second RF generator for calibrating an amplitude of said second waveform, and a digital phase correction circuit for automatically setting and automatically maintaining a target phase difference between said first and said second waveforms.

In some embodiments, the first and second waveforms can be analog waveforms.

In some embodiments, the first amplitude calibration circuit can include a first peak detector circuit configured to generate a first digital amplitude peak detection signal indicative of an amplitude of the first waveform.

In some embodiments, the second amplitude calibration circuit can include a second peak detector circuit configured to generate a second digital amplitude peak detection signal indicative of an amplitude of the second waveform.

In some embodiments, the power supply can further include at least one controller for receiving the first and second digital amplitude peak detection signals and generating at least one amplitude-adjustment control signal.

In some embodiments, the power supply can further include first and second RF gain circuits for receiving the first and second RF waveforms, respectively, and generating first and second amplified RF waveforms.

In some embodiments, the at least one controller can be configured to apply the at least one amplitude-adjustment control signal to at least one of the first and second RF gain circuits, respectively.

In some embodiments, the first radio frequency (RF) generator can be configured to apply the first waveform to a first electrode of an ion mobility mass spectrometer, and the second RF generator can be configured to apply the second waveform to a second electrode of the ion mobility mass spectrometer.

In some embodiments, the power supply can further include a controller configured to determine cross-coupling ratios of said first and second waveforms, and generate correction factors based on said cross-coupling ratios for adjusting said first and second waveforms.

In some embodiments, the digital phase correction circuit can include feedback circuits for generating first and second analog feedback signals each associated with one of the first and second waveforms, and at least one analog-to-digital converter configured to receive the first and second analog feedback signals and convert the first and second analog feedback signals into respective first and second digital feedback signals. The digital phase correction circuit can further include at least one digital passband filter configured to receive the first and second digital feedback signals and generate first and second filtered digital feedback signals by substantially filtering out from each of the first and second digital feedback signals respectively associated with each of the first and second waveforms a contribution associated with the other one of the first and second waveforms due to cross-talk between said first and second waveforms applied to the first and second electrodes. The digital phase correction circuit can further include a phase comparator for determining a phase difference between the first and second filtered digital feedback signals, and a controller for applying a correction signal determined based on the phase difference to said at least one digital waveform synthesizer.

Further understanding of various aspects of the present teachings can be obtained by reference to the following detailed description in conjunction with the associated drawings, which are described briefly below.

### BRIEF DESCRIPTION OF THE DRAWINGS

FIG. 1 schematically depicts a conventional circuit for generating a FAIMS waveform for application to electrodes of a DMS;

FIG. 2 schematically depicts a power supply for generating an FAIMS waveform for application to electrodes of a DMS, according to an embodiment of the disclosure;

FIG. 3 schematically depicts a waveform-generation circuit of the power supply of FIG. 2, according to an embodiment of the disclosure;

FIG. 4 schematically depicts an implementation of peak detector circuits suitable for use in an amplitude calibration circuit of the waveform-generation circuit depicted in FIG. 3;

FIG. 5 illustrates a flow chart for RF amplitude calibration, in accordance with an embodiment of the disclosure;

FIG. 6 illustrates a flow chart for a cross coupling compensation calibration procedure, in accordance with an embodiment of the disclosure;

FIGS. 7 and 8 schematically depict a DMS, according to an embodiment of disclosure; and

FIG. 9 schematically depicts an example of implementation of a phase comparator, a phase controller, and an amplitude calibration controller, in accordance with an embodiment of the disclosure.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also, for brevity, not be discussed in any great detail. The skilled person will recognize that some embodiments of the applicant's teachings may not require certain of the specifically described details in every implementation, which are set forth herein only to provide a thorough understanding of the embodiments. Similarly, it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein, the terms “automatically” and “auto” refer to a device or process working by itself without direct human control. In some cases, an automatic process can be initiated by a human operator, but may not require further human intervention to complete the operations of the process.

As used herein, the term “and/or” includes any and all combinations of one or more of the associated listed items and may be abbreviated as “/”.

As noted above, a DMS can separate ions based on their differential mobility in an asymmetric field generated via application of a separation voltage (SV) across two electrodes of the spectrometer. The separation voltage is commonly generated via application of sinewaves to the electrodes of the mobility cell. For example, the SV can be created by applying a 3 MHz sinewave to one electrode and a 6 MHz sinewave with half the amplitude to the other electrode. The resultant waveform, which will be herein referred to as a FAIMS waveform, can be utilized as the SV for separating ions based on their differential mobility. In order to generate a proper FAIMS waveform, there is a need to control a phase offset between the two sinewaves and the amplitude of the two sinewaves to a high degree of accuracy.

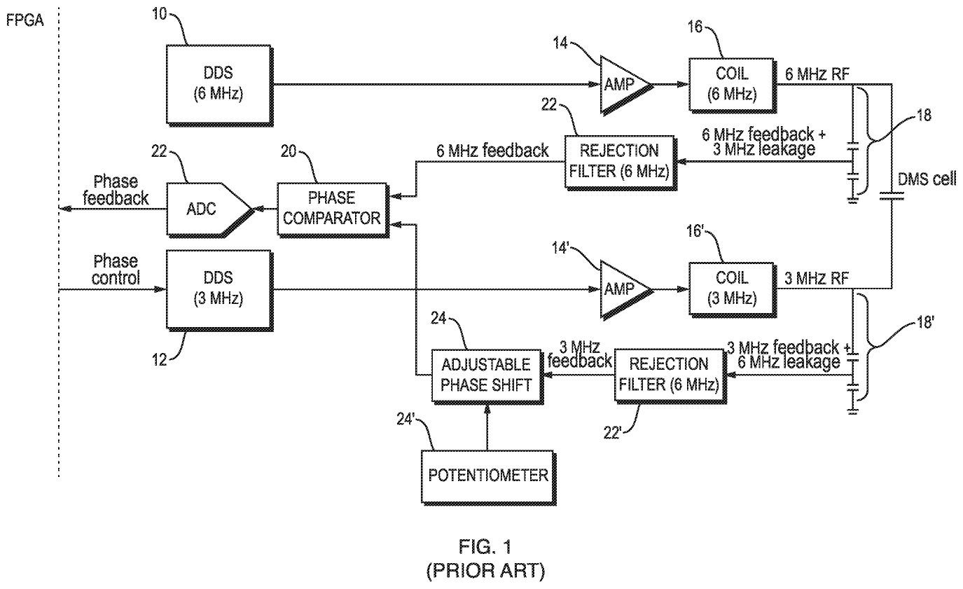

FIG. 1 schematically depicts a conventional circuit for generating a FAIMS waveform via application of two sinewaves with frequencies of 3 MHz and 6 MHz to the electrodes of a DMS cell. The circuit includes two digital direct synthesizers (DDSs) 10 and 12 for generating a 6 MHz and a 3 MHz sinewave, respectively. The 6 MHz sinewave is amplified via an amplifier 14 and is applied via a resonant circuit 16 to one of the electrodes of the DMS cell. The 3 MHz sinewave is, in turn, amplified via an amplifier 14′ and is applied via a resonant circuit 16′ to the other electrode of the DMS cell. Two voltage dividers 18 and 18′ coupled respectively to the outputs of the resonant circuits 16 and 16′ provide feedback signals associated with the 6 MHz and 3 MHz sinewaves, which can be utilized by a phase comparator 20 to provide analog phase feedback signals, which are converted via an analog-to-digital converter (ADC) to digital feedback signals for application to DDS 10 for maintaining a substantially constant phase offset between the two sinewaves.

The above circuit suffers, however, from a significant shortcoming. In particular, each of the 6 MHz and the 3 MHz sinewaves applied to the different electrodes of the DMS cell couple capacitively to the opposing electrode, resulting in feedback signals corresponding to a sum of the two frequencies. However, for proper functioning of the phase comparator, each of the 6 MHz and 3 MHz feedback signals should be as spectrally pure as possible. Therefore, the cross-coupled signals need to be filtered in order to reduce, and preferably eliminate, their interference with the functioning of the phase comparator. In the depicted circuit, two analog rejection filters 22 and 22′ are utilized for filtering out the cross-coupled interfering signals. Such rejection filters, however, can exhibit a wide variation in phase response in the passband e.g., due to incorporation of a large number of capacitors and inductors with significant tolerance, which results in a variable phase offset between each of the RF sinewaves and its respective feedback signal.

Consequently, the phase offset determined by the phase comparator may not correlate well with the true phase offset between the two sinewaves. In order to overcome this problem, an adjustable phase shifter 24, electrically coupled to a potentiometer 24′, can be inserted into one of the feedback paths, e.g., the 3 MHz feedback path in the depicted circuit, and a manual calibration can be performed as part of DMS manufacturing, during which the 3 MHz feedback signal is phase shifted until the FAIMS waveform “looks right” as observed on an oscilloscope. Such a calibration process is, however, time consuming and costly, and its accuracy relies on a visual evaluation of the FAIMS waveform by a human operator.

Moreover, the stopband rejection of the rejection filters can be poor (e.g., 20 dB), resulting in a high noise floor in the phase comparator circuit. This can in turn necessitate maintaining a minimum SV in the DMS cell in order to ensure a proper functioning of the phase offset control loop even when such an SV is not desirable for a proper functioning of the DMS.

Additionally, in many applications, accuracy of the amplitude of the sinewaves generated by the DDSs 10 and 12 is critical for achieving proper SV. Such amplitude accuracy can only be achieved in the conventional circuit illustrated in FIG. 1 using manual calibration, which is time consuming and costly.

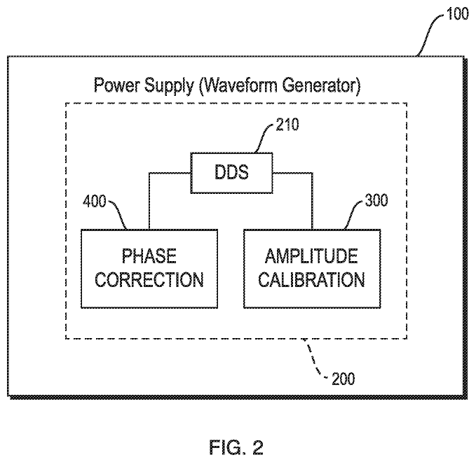

FIG. 2 schematically depicts a power supply 100 including an asymmetric waveform-generation circuit 200 (hereinafter “waveform-generation circuit”) according to an embodiment of this disclosure. The waveform-generation circuit 200 includes waveform generators 210, an amplitude calibration circuit 300, and a digital phase correction circuit 400.

In this embodiment, the waveform generators 210 generate digital sinusoidal waveforms with respective frequencies of 3 MHz and 6 MHz, for example. In other embodiments, the waveform generators 210 can generate sinuosoidal waveforms at other frequencies. Further, in some embodiments, the waveform generators 210 can generate time-dependent waveforms that are not purely sinusoidal. The waveform-generation circuit 200 generates analog output waveforms based on the digital sinusoidal waveforms and applies the analog output waveforms to electrodes of a DMS cell.

During calibration of the waveform-generation circuit 200, the amplitude calibration circuit 300 generates amplitude calibration feedback signals from the analog output waveforms applied to the electrodes and utilizes the amplitude calibration feedback signals to generate a radio frequency (RF) calibration signal for calibrating the RF amplitude of the digital sinusoidal waveforms generated by the waveform generators 210. The digital phase correction circuit 400 generates phase offset feedback signals from the analog output waveforms applied to the electrodes and utilizes the phase offset feedback signals to generate a phase correction signal for aligning the phases of the digital sinusoidal waveforms generated by the waveform generators 210.

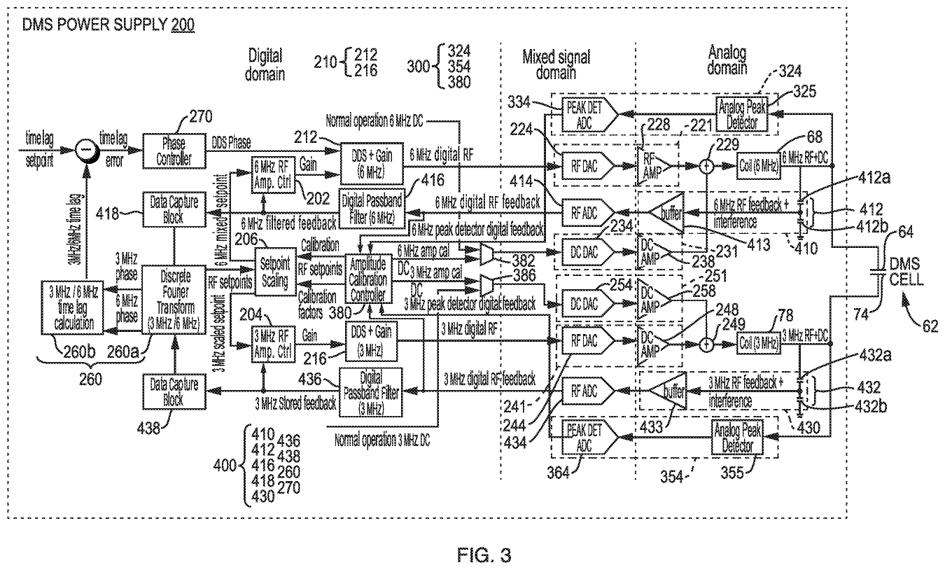

Example embodiments of the waveform-generation circuit 200 will now be described with respect to FIG. 3. Except when otherwise stated, the following description of functions of the waveform-generation circuit 200 with respect to FIG. 3 refers to normal operation (e.g., while performing mass spectrometry) of the waveform-generation circuit 200.

FIG. 3 schematically depicts an embodiment of the waveform-generation circuit 200. In this embodiment, the waveform generators 210 of the waveform-generation circuit 200 include a first digital direct synthesizer (DDS) 212 that generates a first digital sinusoidal waveform at a frequency of about 6 MHz, and a second DDS 216 that generates a second digital sinusoidal waveform at a frequency of about 3 MHz.

The waveform-generation circuit 200 includes a first RF gain circuit 221 and a first DC gain circuit 231. The first RF gain circuit 221 includes a first RF digital-to-analog converter (DAC) 224 that receives the first digital sinusoidal waveform and converts the first digital sinusoidal waveform into a corresponding first analog sinusoidal waveform, and a first RF amplifier 228 that amplifies the first analog sinusoidal waveform to generate a first amplified analog sinusoidal waveform. The first DC gain circuit 231 includes a first DC DAC 234 and a first DC amplifier 238. The first DC DAC 234 receives, through a first multiplexer 382, a first digital DC signal corresponding to a desired magnitude of a first output DC voltage that is generated by the first DC gain circuit 231, and generates a first analog DC signal corresponding to the first digital DC signal. The first DC amplifier 238 receives the first analog DC signal and generates the first output DC voltage based on the first analog DC signal. The first output DC voltage can include an offset voltage and/or a compensation voltage.

The first amplified analog sinusoidal waveform generated by the first RF gain circuit 221 and the first output DC voltage generated by the first DC gain circuit 231 are applied to a first summer 229. The first summer 229 sums the first amplified analog sinusoidal waveform and the first output DC voltage to generate a first RF+DC waveform, and applies the first RF+DC waveform to a first tank circuit 68 of a DMS cell 62. For example, the first tank circuit 68 can include a coil, a resonant gain element, a resonant LC tank circuit, or a transformer. The first tank circuit 68 can be configured in a manner known in the art, such that the first tank circuit 68 would exhibit a resonant frequency that is substantially equal to the frequency of the first RF+DC waveform (e.g., the 6 MHz signal).

The first tank circuit 68 receives the first RF+DC waveform from the first summer 229 and generates a first output analog waveform for application to a first electrode 64 of the DMS cell 62. The first output analog waveform can include compensation voltage (DC), separation voltage (RF) and offset components (DC). The first RF amplifier 228 can generate voltages in the range of tens of volts, which can be amplified to about 5 kV by the coil of the first tank circuit 68. The first DC amplifier 238 can generate a voltage of about 500V or greater, which passes through the coil of the first tank circuit 68 without further amplification. The high precision and accuracy of the first DC amplifier 238 ensures accurate separation voltage configuration.

Still referring to FIG. 3, the waveform-generation circuit 200 includes a second RF gain circuit 241 and a second DC gain circuit 251. The second RF gain circuit 241 includes a second RF digital-to-analog converter (DAC) 244 that receives the second digital sinusoidal waveform and converts the second digital sinusoidal waveform into a corresponding second analog sinusoidal waveform, and a second RF amplifier 248 that amplifies the second analog sinusoidal waveform to generate a second amplified analog sinusoidal waveform. The second DC gain circuit 251 includes a second DC DAC 254 and a second DC amplifier 258. The second DC DAC 254 receives, through a second multiplexer 386, a second digital DC signal corresponding to a desired magnitude of a second output DC voltage that is generated by the second DC gain circuit 251, and generates a second analog DC signal corresponding to the second digital DC signal. The second DC amplifier 258 receives the second analog DC signal and generates the second output DC voltage based on the second analog DC signal. Similar to the first output DC voltage, the second output DC voltage can include an offset voltage and/or a compensation voltage.

The second amplified analog sinusoidal waveform generated by the second RF gain circuit 241 and the second output DC voltage generated by the second DC gain circuit 251 are applied to a second summer 249. The second summer 249 sums the second amplified analog sinusoidal waveform and the second output DC voltage to generate a second RF+DC waveform, and applies the second RF+DC waveform to a second tank circuit 78 of the DMS cell 62. For example, the second tank circuit 78 can include a coil, a resonant gain element, a resonant LC tank circuit, or a transformer. The second tank circuit 78 can be configured in a manner known in the art, such that the second tank circuit 78 would exhibit a resonant frequency that is substantially equal to the frequency of the second RF+DC waveform (e.g., the 3 MHz signal).

The second tank circuit 78 receives the second RF+DC waveform from the second summer 249 and generates a second output analog waveform for application to a second electrode 74 of the DMS cell 62. The second output analog waveform can include compensation voltage (DC), separation voltage (RF) and offset components (DC). The second RF amplifier 248 can generate voltages in the range of tens of volts, which can be amplified to about 5 kV by the coil of the second tank circuit 78. The second DC amplifier 258 can generate a voltage of about 500V or greater, which passes through the coil of the second tank circuit 78 without further amplification. Similar to the first DC amplifier 238, the high precision and accuracy of the second DC amplifier 258 ensures accurate separation voltage configuration.

Still referring to FIG. 3, the waveform-generation circuit 200 includes a first RF amplitude controller 202 configured to generate a first amplitude control signal and apply the first amplitude control signal to the first DDS 212 to apply a first gain to the first digital sinusoidal waveform generated by the first DDS 212, and a second RF amplitude controller 204 configured to generate a second amplitude control signal and apply the second amplitude control signal to the second DDS 216 to apply a second gain to the second digital sinusoidal waveform generated by the second DDS 216. The first and second gains can each have values between 0 and 1, where 1 corresponds to maximum RF DAC output. As described later in more detail, the waveform-generation circuit 200 can further include a setpoint scaler 206 that provides a first scaled RF setpoint and a second scaled RF setpoint to the first and second RF amplitude controllers 202 and 204, respectively, and the first and second RF amplitude controllers 202 and 204 can apply the first and second gains based on the first and second scaled RF setpoints, respectively.

Referring again to FIG. 3, the amplitude calibration circuit 300 includes a first peak detector circuit 324 coupled to the output of the first tank circuit 68, a second peak detector circuit 354 coupled to the output of the second tank circuit 78, and an amplitude calibration controller 380. The amplitude calibration controller 380 is connected to the first and second peak detector circuits 324 and 354, and the setpoint scaler 206.

Although the amplitude calibration controller 380, the first RF amplitude controller 202, the second RF amplitude controller 204, and the setpoint scaler 206 are shown and described as separate components, any one or more of the amplitude calibration controller 380, the first RF amplitude controller 202, the second RF amplitude controller 204, and the setpoint scaler 206 can be integrated into a single controller.

During a calibration mode of the waveform-generation circuit 200, which will be described later, the first peak detector circuit 324 measures the amplitude of the first output analog waveform applied to the first electrode 64 based on the first digital sinusoidal waveform generated by the first DDS 212, and the second peak detector circuit 354 measures the amplitude of the second output analog waveform applied to the second electrode 74 based on the second digital sinusoidal waveform generated by the second DDS 216.

For example, the first peak detector circuit 324 includes a first analog peak detector 325 that, during calibration of the waveform-generation circuit 200, generates an analog signal corresponding to an amplitude of the RF+DC voltage of the first output analog waveform applied to the first electrode 64, and a first peak detector ADC 334 that is connected to the amplitude calibration controller 380 and converts the analog signal from the first analog peak detector 325 to a first digital amplitude peak detection signal that corresponds to the peak magnitude of the RF+DC voltage of the first output analog waveform. The second peak detector circuit 354 includes a second analog peak detector 355 that, during calibration of the waveform-generation circuit 200, generates an analog signal corresponding to an amplitude of the RF+DC voltage of the second output analog waveform applied to the second electrode 74, and a second peak detector ADC 364 that is connected to the amplitude calibration controller 380 and converts the analog signal from the second analog peak detector 355 to a second digital amplitude peak detection signal that corresponds to the peak magnitude of the RF+DC voltage of the second output analog waveform applied to the second electrode 74.

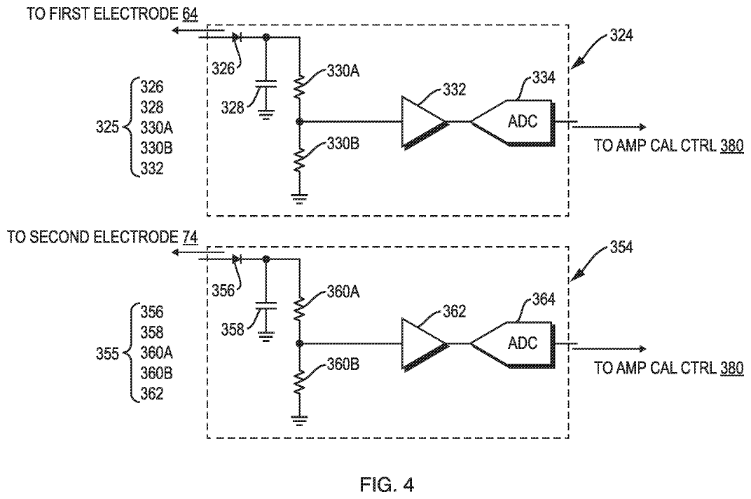

Example embodiments of the first and second peak detector circuits 324 and 354 are shown in FIG. 4. More specifically, FIG. 4 illustrates example configurations of the first and second analog peak detectors 325 and 355.

Referring to FIG. 4, the first analog peak detector 325 of the first peak detector circuit 324 can include a diode 326, a capacitor 328, resistors 330A and 330B, and an amplifier 332. The resistors 330A and 330B can act as a voltage divider to produce a divided voltage that is applied to the amplifier 332 for providing gain to the measured signal before the measured signal is converted to the first digital amplitude peak detection signal by the first peak detector ADC 334. The capacitor 328 and the diode 326 configure the measured signal to represent the peak of the RF voltage of the first output analog waveform, as opposed to a scaled down version of it.

Still referring to FIG. 4, the second analog peak detector 355 of the second peak detector circuit 354 can include a diode 356, a capacitor 358, resistors 360A and 360B, and an amplifier 362. The resistors 360A and 360B can act as a voltage divider to produce a divided voltage that is applied to the amplifier 362 for providing gain to the measured signal before the measured signal is converted to the second digital amplitude peak detection signal by the second peak detector ADC 364. The capacitor 358 and the diode 356 configure the measured signal to represent the peak of the RF voltage of the second output analog waveform.

Further details of first and second peak detector circuits 324 and 354 are provided in International Application Publication No. WO 2022/269471 A1, the entire disclosure of which is incorporated herein by reference.

During normal operation of the waveform-generation circuit 200, the amplitude calibration controller 380 generates a first RF amplitude-adjustment control signal based on the results of the first RF amplitude calibration. The amplitude calibration controller 380 applies the first RF amplitude-adjustment control signal to the setpoint scaler 206, which provides a signal including the first scaled RF setpoint to the first RF amplitude controller 202 based on a first input RF setpoint and the first RF calibration factor. Thus, the first RF amplitude controller 202 adjusts the first RF amplitude based on the first RF amplitude-adjustment control signal generated by the amplitude calibration controller 380.

Further, during normal operation of the waveform-generation circuit 200, the amplitude calibration controller 380 generates a second RF amplitude-adjustment control signal based on the results of the second RF amplitude calibration. The amplitude calibration controller 380 applies the second RF amplitude-adjustment control signal to the setpoint scaler 206, which provides a signal including the second scaled RF setpoint to the second RF amplitude controller 204 based on a second input RF setpoint and the second RF calibration factor. Thus, the second RF amplitude controller 204 adjusts the second RF amplitude based on the second RF amplitude-adjustment control signal generated by the amplitude calibration controller 380.

The phase correction circuit 400 will now be described with reference to FIG. 3.

Referring back to FIG. 3, during normal operation, the phase correction circuit 400 generates RF feedback signals by sampling scaled-down copies of the first and second output analog waveforms applied to the electrodes 64 and 74, and utilizes those phase offset feedback signals to generate a phase correction signal for aligning the phases of the sinusoidal waveforms generated by the first DDS 212 and the second DDS 216.

For example, in the embodiment illustrated in FIG. 3, the phase correction circuit 400 includes a first RF feedback circuit 410. The first RF feedback circuit 410 includes a first voltage divider 412 coupled at an input thereof to the output of the first tank circuit 68, and a first buffer 413 connected to the first voltage divider 412.

The first voltage divider 412 is configured to generate a 6 MHz analog feedback signal. For example, in this embodiment, the first voltage divider 412 can be implemented as two capacitors 412a/412b that are electrically connected in series, where the junction between the two capacitors 412a/412b corresponds to the output of the first voltage divider 412. The voltage at the output of the first voltage divider 412 is a fraction of the voltage at the input of the first voltage divider 412, in this case by a ratio of the impedance of the capacitor 412b at 6 MHz relative to the combined impedance of the capacitors 412a/412b at 6 MHz. The output voltage of the first voltage divider 412 provides a first analog feedback signal to the first buffer 413.

The phase correction circuit 400 further includes a first analog-to-digital converter (ADC) 414 connected to the first buffer 413, and a first digital passband filter 416 connected to the first ADC 414 and the first DDS 212. The first ADC 414 receives the first analog feedback signal from the first buffer 413 and converts the first analog feedback signal to a digital feedback signal associated with the 6 MHz sinusoidal waveform (herein also referred to as the first digital feedback signal). The first digital feedback signal is received by the first digital passband filter 416, which rejects any signal at a frequency of 3 MHz, which may have been coupled, via capacitive coupling, across the first and second electrodes 64 and 74 to the first analog feedback signal at the frequency of 6 MHz, to generate a first filtered digital feedback signal.

The phase correction circuit 400 includes a first data capture element 418 (herein also referred to as a first data capture block) that receives the first filtered digital feedback signal and stores the first filtered digital feedback signal for application to a phase comparator 260.

With continued reference to FIG. 3, the phase correction circuit 400 includes a second RF feedback circuit 430. The second RF feedback circuit 430 includes a second voltage divider 432 coupled at an input thereof to the output of the second tank circuit 78, and a second buffer 433 connected to the second voltage divider 432.

The second voltage divider 432 is configured to generate a 3 MHz analog feedback signal. Similar to the first voltage divider 412, the second voltage divider 432 includes two capacitors 432a/432b that are electrically coupled in series with the voltage at the junction of the two capacitors 432a/432b, where the junction between the two capacitors 432a/432b corresponds to the output of the second voltage divider 432. The voltage at the output of the second voltage divider 432 is a fraction of the voltage at the input of the second voltage divider 432, in this case by a ratio of the impedance of the capacitor 432b at 3 MHz relative to the combined impedance of the capacitors 432a/432b at 3 MHz. The output voltage of the second voltage divider 432 provides a second analog feedback signal to the second buffer 433.

The phase correction circuit 400 further includes a second analog-to-digital converter (ADC) 434 connected to the second buffer 433, and a second digital passband filter 436 connected to the second ADC 434 and the second DDS 216. The second ADC 434 receives the second analog feedback signal from the second buffer 433 and converts the second analog feedback signal to a digital feedback signal associated with the 3 MHz sinusoidal waveform (herein also referred to as the second digital feedback signal). The second digital feedback signal is received by the second digital passband filter 436, which rejects any signal at a frequency of 6 MHz, which may have been coupled, via capacitive coupling, across the first and second electrodes 64 and 74 to the second analog feedback signal at the frequency of 3 MHz, to generate a second filtered digital feedback signal.

The phase correction circuit 400 further includes a second data capture element 438 (herein also referred to as a second data capture block) that receives the second filtered digital feedback signal and stores the second filtered digital feedback signal for application as another input signal to the phase comparator 260.

The phase comparator 260 includes a Discrete Fourier Transform module 260a that receives the first and the second filtered digital feedback signals and operates on those signals to generate the frequency spectra associated with the first and second filtered digital feedback signals. The phase comparator 260 further includes a computational module 260b that receives the frequency spectra associated with the 6 MHz and the 3 MHz signals generated by the Discrete Fourier Transform module to determine a phase shift (e.g., in the form of a time lag) between the first and the second filtered digital feedback signals. The computational module 260b can also include functionality, as shown schematically in FIG. 3, to compare the measured phase shift with a preset phase shift (i.e., a desired phase shift between the two sinusoidal waveforms) to determine a phase error, i.e., the degree by which the measured phase shift deviates from the preset phase shift. A phase controller 270 receives the computed phase error from the phase comparator and generates a phase correction signal, in a manner known in the art as informed by the present teachings, for application to the first DDS 212 so as to align the phases of the waveforms generated by the first DDS 212 and the second DDS 216.

In some embodiments, the first and second RF feedback circuits 410 and 430 can also be implemented to perform RF amplitude control during normal operation of the waveform-generation circuit 200. As illustrated in FIG. 3, the first RF amplitude controller 202 is connected to the first digital passband filter 416, and the second RF amplitude controller 204 is connected to the second digital passband filter 436. Thus, the first RF amplitude controller 202 can receive the first filtered digital feedback signal from the first digital passband filter 416, and the second RF amplitude controller 204 can receive the second filtered digital feedback signal from the second digital passband filter 436.

To implement the RF amplitude control, the first RF amplitude controller 202 can utilize the first filtered digital feedback signal from the first digital passband filter 416 to control the first gain applied to the first DDS 212, and the second RF amplitude controller 204 can utilize the second filtered digital feedback signal from the second digital passband filter 436 to control the second gain applied to the second DDS 216. Thus, the first and second gains can be controlled by respective RF feedback loops to ensure high accuracy in the output voltage of the first and second tank circuits 68 and 78.

Calibration of the waveform-generation circuit 200, according to example embodiments, will now be described.

### Calibration of the Waveform-Generation Circuit (Auto-Calibration)

Referring to FIG. 3, in a calibration mode of the waveform-generation circuit 200, the amplitude calibration circuit 300 of the waveform-generation circuit 200 automatically determines the errors in the RF feedback circuits (412a/412b and 432a/432b) by utilizing the very precise DC outputs and the peak detectors and associated feedback paths (first peak detector circuit 324/second peak detector circuit 354). The measurement of the RF feedback errors informs the calculation of calibration factors, which are then applied to the RF setpoints during normal operation, in order to compensate for said errors, thus resulting in highly accurate RF signals applied to the DMS cell.

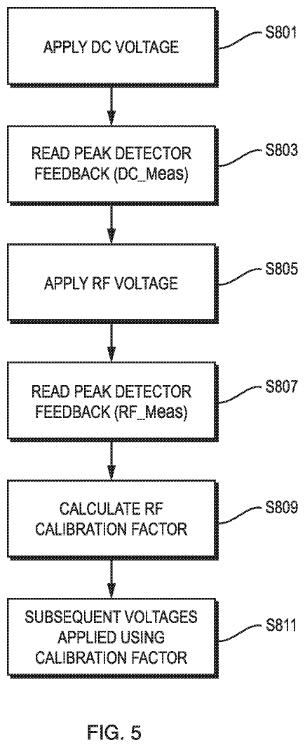

The RF amplitude calibration sequence is as shown in FIG. 5 (apply DC signal only, then measure peak detector feedback, then apply RF signal only, then measure peak detector feedback, and then calculate RF calibration factor). More details regarding the RF amplitude calibration sequence can be found in International Application Publication No. WO 2022/269471 A1. During RF amplitude calibration, the first and second calibration factors are set to 1 (as they are yet to be determined for normal operation at this point), and the calibration RF setpoints pass through the setpoint scaler 206 unmodified. After the first and second RF calibration factors are determined, as the DMS switches to normal operation, the determined first and second RF calibration factors are applied to the RF setpoints.

FIG. 5 illustrates a flow chart for RF amplitude calibration, in accordance with an example embodiment of the disclosure. Referring to FIG. 5, the process starts in step S801 in which a DC voltage can be applied to the first/second tank circuit 68/78 targeting 500V DC, for example, output at the first/second tank circuit 68/78. In this scenario, a DC amplitude calibration signal can be provided to the first/second DC DAC 234/254, the DC amplitude calibration signal corresponding to a desired 500V output at the first/second tank circuit 68/78. The first/second DC amplifier 238/258 therefore generates an output DC voltage that is passed through the first/second summer 229/249, summing with a null RF signal resulting in an output DC signal applied to the first/second tank circuit 68/78.

In step S803, the first/second peak detector circuit 324/354 can provide a measurement of the signal generated by the first/second tank circuit 68/78 by providing a DC calibration measurement signal, DC_Meas, to the amplitude calibration controller 380 via the voltage divider resistors 330A and 330B/360A and 360B, the amplifier 332/362, and the first/second peak detector ADC 334/364.

In step S805, an RF signal can be applied to the first/second tank circuit 68/78 with a desired output voltage of the first/second tank circuit 68/78 at 500V, for example. In this scenario, the amplitude calibration controller 380 can communicate with the first/second DDS 212/216 through the setpoint scaler 206 and the first/second RF amplitude controller 202/204 to apply a digital RF signal to the first/second RF DAC 224/244, the digital RF signal corresponding to a desired 500V output at the first/second tank circuit 68/78. The first/second RF amplifier 228/248 therefore generates an output RF voltage that is passed through the summer 229/249, summing with a 0V DC signal, for example, resulting in an output RF signal applied to the first/second tank circuit 68/78.

In step S807, the first/second peak detector circuit 324/354 can provide a measurement of the signal output by the first/second tank circuit 68/78 by providing an RF calibration measurement signal, RF_Meas, to the amplitude calibration controller 380 via the voltage divider resistors 330A and 330B/360A and 360B, the amplifier 332/362, and the first/second peak detector ADC 334/364. In step S809, an RF calibration factor can be calculated. In one example, the RF calibration factor can be defined as: RF_cal_factor=DC_Meas/RF_Meas and calculated by the amplitude calibration controller 380, for example. In another example, the RF calibration factor may only take into account the RF calibration measurement. In yet another example, the calculation of the RF calibration factor may take into account the voltage drop across the diode 326/356. After the RF calibration factor has been calculated, the process can continue in step S811 in which subsequent RF voltages applied to the first/second tank circuit 68/78 can be configured using this calibration factor.

Because the RF calibration factor is calculated ratiometrically to the highly accurate DC amplifier output, errors in both the RF control loop feedback and the peak detector circuit are reduced, yielding a great improvement in the accuracy of the RF voltage applied to the first/second tank circuit 68/78. In another example, a highly accurate peak detector circuit may be utilized to calibrate the RF voltage directly without reference to the DC voltage.

Referring back to FIG. 3, in some embodiments, the waveform-generation circuit 200 can be configured to perform cross-coupling compensation in order to minimize cross coupling of the 6 MHz and 3 MHz RF channels. More specifically, the first and second electrodes 64 and 74 capacitively couple to each other. This phenomenon is known as cross-coupling. Although the bulk of cross-coupling can be removed by analog filters, a small percentage of cross-coupling still leaks through the filters. Therefore, the effective 3 MHz (6 MHz) RF voltage, which is the difference between the two electrodes 64 and 74, is diminished. The cross-coupling compensation can be implemented to address this issue.

Referring to FIG. 3, during calibration of the waveform-generation circuit 200 to account for cross-coupling to the 6 MHz channel, feedback can be measured in the first RF feedback circuit 410. More specifically, when a first RF signal is applied to the first tank circuit 68, the first RF feedback circuit 410 can measure the output voltage of the first tank circuit 68 and provide a first digital feedback signal, RF_Feedback_1, to the amplitude calibration controller 380. Moreover, the second RF feedback circuit 430 can measure the output of the second tank circuit 78, and provide a first cross-coupled digital feedback signal, RF_Feedback_CC_1 (corresponding to the cross-coupled first RF signal), to the amplitude calibration controller 380. The amplitude calibration controller 380 receives both digital feedback signals RF_Feedback_1 and RF_Feedback_CC_1, and calculates a first cross-coupling ratio R_{CC_1} based on the first digital feedback signal RF Feedback_1 and the first cross coupled digital feedback signal RF_Feedback_CC_1, where

$${R}_{CC \_ 1} = \frac{RF\_Feedback \_CC \_ 1}{RF\_Feedback \_ 1} .$$

The amplitude calibration controller 380 can then apply the first cross-coupling ratio R_{CC_1} to the first RF calibration factor RF_cal_factor to adjust the first RF calibration factor RF_cal_factor in order to also mitigate against the effects of cross-coupling.

Referring again to FIG. 3, during calibration of the waveform-generation circuit 200 to account for cross-coupling to the 3 MHz channel, feedback can be measured in the second RF feedback circuit 430. More specifically, when a second RF signal is applied to the second tank circuit 78, the second RF feedback circuit 430 can measure the output voltage of the second tank circuit 78 and provide a second digital feedback signal, RF_Feedback_2, to the amplitude calibration controller 380. Moreover, the first RF feedback circuit 410 can measure the output of the first tank circuit 68, and provide a second cross-coupled digital feedback signal, RF_Feedback_CC_2 (corresponding to the cross-coupled second RF signal), to the amplitude calibration controller 380. The amplitude calibration controller 380 receives both digital feedback signals RF_Feedback_2 and RF_Feedback_CC_2, and calculates a second cross-coupling ratio R_{CC_2} based on the second digital feedback signal RF_Feedback_2 and the second cross-coupled digital feedback signal RF_Feedback_CC_2, where

$${R}_{CC \_ 2} = \frac{RF\_Feedback \_CC \_ 2}{RF\_Feedback \_ 2} .$$

The amplitude controller 380 can then apply the second cross-coupling ratio R_{CC_2} to the second RF calibration factor RF_cal_factor to adjust the second RF calibration factor RF_cal_factor in order to also mitigate the effects of cross-coupling.

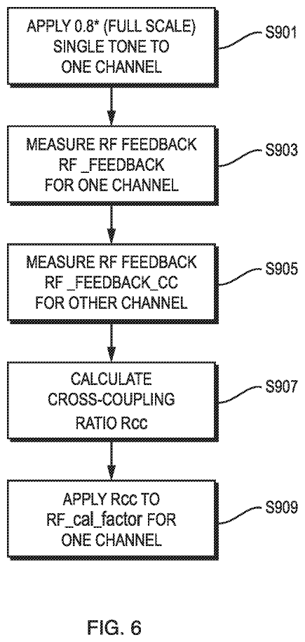

FIG. 6 illustrates a flow chart for a cross-coupling compensation calibration procedure, in accordance with an embodiment of the disclosure.

Referring to FIG. 6, at power up, as part of the overall calibration process, the cross coupling compensation circuit of the waveform-generation circuit 200 can perform an automatic cross coupling compensation calibration process to calculate cross coupling ratios and apply corrections to the RF_cal_factor values calculated at a previous step, in order to account for cross coupling. The cross coupling compensation calibration process for each of the 3 MHz and 6 MHz RF channels can start in step S901 in which a 0.8*(full scale) single tone RF is applied to one RF channel (i.e., one of the first and second tank circuits 68 and 78) (this translates to 4000V for the 3 MHz side, and 2000V for the 6 MHz side). Then, in step S903, the digital feedback signal RF Feedback for the RF channel to which the single tone RF was applied can be measured. Next, in step S905, the digital feedback signal for the other RF channel RF_Feedback_CC (if calculating the 3 MHz cross coupling, the other channel is 6 MHz, and vice versa) can be measured. In step S907, a cross coupling ratio R_{CC} can be calculated, where

$${R}_{CC} = \frac{RF\_Feedback \_CC}{RF\_Feedback} .$$

Then, in step S909, the cross coupling ratio R_{CC} can be applied to the RF calibration factor RF_cal_factor for the channel to which the single tone RF was applied, to calibrate the waveform-generation circuit 200 for mitigation of the effects of cross coupling.

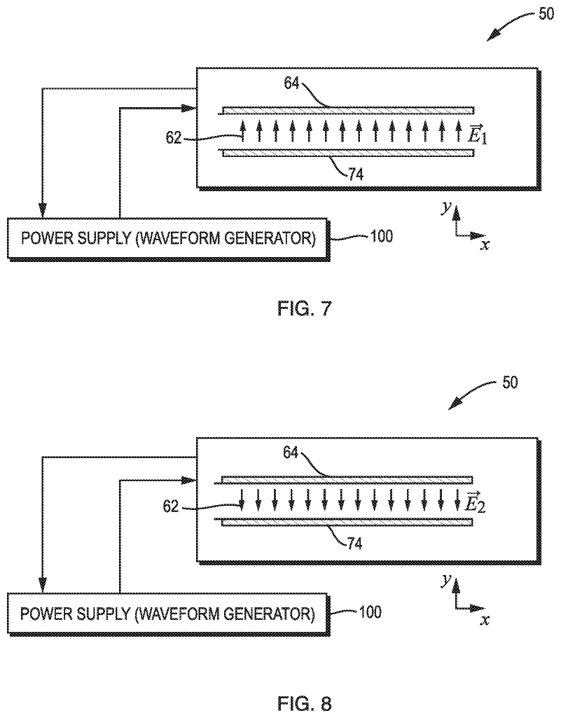

A power supply according to the present teachings can be employed in a variety of different applications, including in a variety of different mass spectrometry systems. By way of example, FIGS. 7 and 8 schematically depict a high-field asymmetric-waveform differential mobility mass spectrometer (DMS) 50 in which the power supply 100 including the asymmetric waveform-generation circuit 200 according to the present teachings is incorporated. Referring to FIGS. 7 and 8, the DMS 50 includes the DMS cell 62 in which the two electrodes 64 and 74, in the form of two plates in this embodiment, are positioned. The two electrodes 64 and 74 are separated by a space through which the DMS 50 can receive, via an inlet thereof, a plurality of ions (not shown). In operation, the waveform-generation circuit 200 creates a time-varying, asymmetric, electric field E1 and E2 between the two electrodes 64 and 74. By way of example, and without limitation, the two electrodes 64 and 74 can be parallel strip electrodes, parallel plate electrodes, concentric cylinders, curved elements, among others.

Ions travel between the electrodes along the x direction, orthogonal to the direction of the time-varying electric field. The asymmetric, time-varying electric field imparts a net drift to the ions in the y direction.

The power supply 100 can be implemented in a manner discussed herein to provide an asymmetric time-varying electric field between the two electrodes 64 and 74 to which the ions are exposed as they travel between the two electrodes.

Various components utilized in a circuit according to the present teachings, such as the above asymmetric waveform-generation circuit 200, are commercially available and/or can be implemented in a manner known in the art as informed by the present teachings.

By way of example, the phase controller 270, the phase comparator 260, the first RF amplitude controller 202, the second RF amplitude controller 204, the setpoint scaler 206, and the amplitude calibration controller 380 can be implemented in hardware, firmware and/or software using techniques known in the art as informed by the present teachings. By way of example, FIG. 10 schematically depicts an example of such implementation.

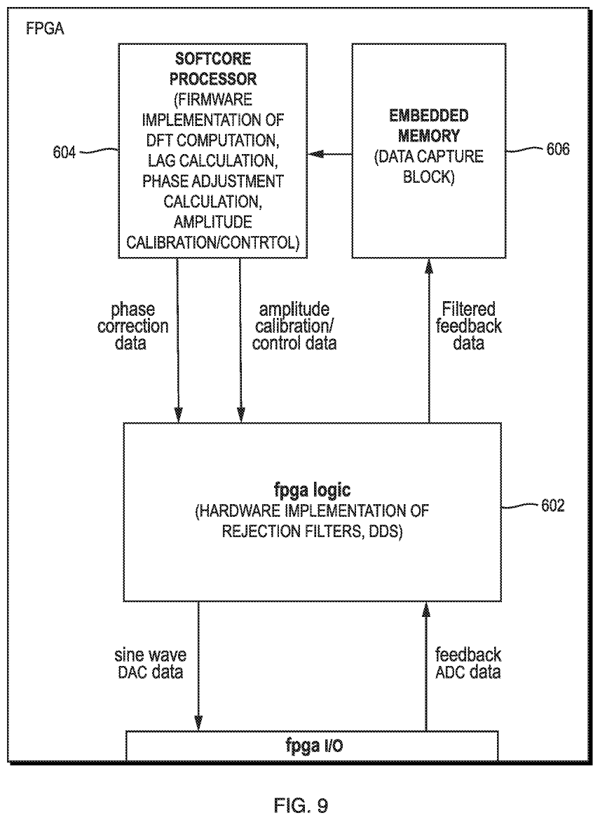

As shown in FIG. 9, the phase controller 270, the first RF amplitude controller 202, the second RF amplitude controller 204, and the amplitude calibration controller 380 can be implemented using Field Programmable Gate Arrays (FPGAs). The example implementation includes a logic module 602 that is a hardware implementation of the first and second DDSs 212 and 216 as well as the first and second digital passband filters 416 and 436. The logic module 602 is configured to receive the digital feedback signals from feedback ADCs via an I/O interface and operate on the digital feedback signals to generate filtered digital feedback signals, which are stored in an embedded memory 606 (herein also referred to as data capture block).

A softcore processor 604 can receive the data corresponding to the first and second filtered digital feedback signals from the embedded memory 606 and operate on the data in a manner disclosed herein to obtain a phase difference between the first and second digital feedback signals and further generate a phase correction signal.

More specifically, the softcore processor 604 is configured to apply a Discrete Fourier Transform (DFT) to the first and second filtered digital feedback signals to generate frequency spectra corresponding to the first and second filtered digital feedback signals. Further, the softcore processor 604 is configured to utilize the frequency spectra to compute a phase difference between the first and second filtered digital feedback signals and compare the computed phase difference with a preset phase difference (i.e., a desired phase difference) to generate phase adjustment (compensation) data (signal), which is applied one of the DDSs for aligning the phases of the two DDSs.

Additionally, softcore processor 604 can utilize the digital amplitude peak detection signal s during calibration of the power supply to calibrate DC offset and/or DC compensation voltages to be utilized during operation of the power supply. The softcore processor 604 can also be operable to utilize digital RF calibration signals.

Additionally, softcore processor 604 can utilize RF control loop feedback channels to perform cross coupling compensation.

Further, the first and second digital waveforms generated by the first and second DDSs included in the logic module 602 can be converted by external DACs to generate analog sinewaves, which can be amplified and applied to the electrodes 64 and 74 in a manner discussed above.

According to embodiments disclosed herein, amplitude and phase control methods such that they are capable of self-calibration. Amplitude self-calibration employs a circuit that calibrates an RF feedback path using the high precision DC power supply outputs. Phase self-calibration is accomplished by using digital processing techniques for implementing functional blocks (e.g., cross-coupling rejection filters, and phase offset calculation) that were previously implemented using analog hardware.

The embodiments disclosed herein mitigate problems caused by variability in analog components, either by accounting for such variability (amplitude calibration), or eliminating components themselves (phase calibration). The precision of the calibration results according to the embodiments disclosed herein is also greatly improved as compared to manual calibration, as the calibration methods of the disclosed embodiments do not rely on visual evaluation of an FAIMS waveform by an operator.

The foregoing description of the embodiments has been presented for purposes of illustration only. It is not exhaustive and does not limit the embodiments to the precise form disclosed. While several exemplary embodiments and features are described, modifications, adaptations, and other implementations may be possible, without departing from the spirit and scope of the embodiments. Accordingly, unless explicitly stated otherwise, the descriptions relate to one or more embodiments and should not be construed to limit the embodiments as a whole. This is true regardless of whether or not the disclosure states that a feature is related to “a,” “the,” “one,” “one or more,” “some,” or “various” embodiments. As used herein, the singular forms “a,” “an,” and “the” may include the plural forms unless the context clearly dictates otherwise. Further, the term “coupled” does not exclude the presence of intermediate elements between the coupled items. Also, stating that a feature may exist indicates that the feature may exist in one or more embodiments.

In this disclosure, the terms “include,” “comprise,” “contain,” and “have,” when used after a set or a system, mean an open inclusion and do not exclude addition of other, non-enumerated, members to the set or to the system. Further, unless stated otherwise or deducted otherwise from the context, the conjunction “or,” if used, is not exclusive, but is instead inclusive to mean and/or. Moreover, if these terms are used, a subset of a set may include one or more than one, including all, members of the set.

Further, if used in this disclosure, and unless stated or deducted otherwise, a first variable is an increasing function of a second variable if the first variable does not decrease and instead generally increases when the second variable increases. On the other hand, a first variable is a decreasing function of a second variable if the first variable does not increase and instead generally decreases when the second variable increases. In some embodiment, a first variable may be an increasing or a decreasing function of a second variable if, respectively, the first variable is directly or inversely proportional to the second variable.

The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Modifications and variations are possible in light of the above teachings or may be acquired from practicing the embodiments. For example, the described steps need not be performed in the same sequence discussed or with the same degree of separation. Likewise various steps may be omitted, repeated, combined, or performed in parallel, as necessary, to achieve the same or similar objectives. Similarly, the systems described need not necessarily include all parts described in the embodiments and may also include other parts not described in the embodiments. Accordingly, the embodiments are not limited to the above-described details, but instead are defined by the appended claims in light of their full scope of equivalents. Further, the present disclosure is directed toward all novel and non-obvious features and aspects of the various disclosed embodiments, alone and in various combinations and sub-combinations with one another.

While the present disclosure has been particularly described in conjunction with specific embodiments, many alternatives, modifications, and variations will be apparent in light of the foregoing description. It is therefore contemplated that the appended claims will embrace any such alternatives, modifications, and variations as falling within the true spirit and scope of the present disclosure.

Those having ordinary skill in the art will appreciate that various changes can be made to the above embodiments without departing from the scope of the present teachings.

1. A power supply, comprising:
a first radio frequency (RF) generator for generating a first waveform,
a second RF generator for generating a second waveform,
a first amplitude calibration circuit operably coupled to said first RF generator for calibrating an amplitude of said first waveform,
a second amplitude calibration circuit operably coupled to said second RF generator for calibrating an amplitude of said second waveform, and
a digital phase correction circuit for automatically setting and automatically maintaining a target phase difference between said first and said second waveforms.

2. The power supply of claim 1, wherein said first and second waveforms are analog waveforms.

3. The power supply of claim 1, wherein said first amplitude calibration circuit comprises:
a first peak detector circuit configured to generate a first digital amplitude peak detection signal indicative of an amplitude of said first waveform.

4. The power supply of claim 3, wherein said second amplitude calibration circuit comprises:
a second peak detector circuit configured to generate a second digital amplitude peak detection signal indicative of an amplitude of said second waveform.

5. The power supply of claim 4, further comprising at least one controller for receiving said first and second digital amplitude peak detection signals and generating at least one amplitude-adjustment control signal.

6. The power supply of claim 1, further comprising first and second RF gain circuits for receiving said first and second waveforms, respectively, and generating first and second amplified RF waveforms.

7. The power supply of claim 6, wherein said at least one controller is configured to apply said at least one amplitude-adjustment control signal to at least one of said first and second RF gain circuits, respectively.

8. The power supply of claim 1, wherein:
the first radio frequency (RF) generator is configured to apply the first waveform to a first electrode of an ion mobility mass spectrometer, and
the second RF generator is configured to apply the second waveform to a second electrode of said ion mobility mass spectrometer.

9. The power supply of claim 1, further comprising a controller configured to determine cross-coupling ratios of said first and second waveforms, and generate correction factors based on said cross-coupling ratios for adjusting said first and second waveforms.

10. The power supply of claim 8, wherein said digital phase correction circuit comprises:
a feedback circuit for generating first and second analog feedback signals each associated with one of said first and second waveforms,
at least one analog-to-digital converter configured to receive said first and second analog feedback signals and convert said first and second analog feedback signals into respective first and second digital feedback signals,
at least one digital passband filter configured to receive said first and second digital feedback signals and generate first and second filtered digital feedback signals by substantially filtering out from each of the first and second digital feedback signals respectively associated with each of said first and second waveforms a contribution associated with the other one of the first and second waveforms due to cross-talk between said first and second waveforms applied to the first and second electrodes,
a phase comparator for determining a phase difference between said first and second filtered digital feedback signals, and
a controller for applying a correction signal determined based on said phase difference to said at least one digital waveform synthesizer.
